(19) United States
(12) Patent Application Publication
(10) Pub. No.: US 2026/0092880 A1
(43) Pub. Date: Apr. 2, 2026

(54) RF SENSOR

(71) Applicant: BILKENT UNIVERSITESI ULUSAL NANOTEKNOLOJI ARASTIRMA MERKEZI, ANKARA (TR)

(72) Inventors: HILMI VOLKAN DEMIR, ANKARA (TR); SOBHAN GHOLAMI, ANKARA (TR); EMRE UNAL, ANKARA (TR)

(73) Assignee: BILKENT UNIVERSITESI ULUSAL NANOTEKNOLOJI ARASTIRMA MERKEZI, ANKARA (TR)

(21) Appl. No.: 19/003,581

(22) Filed: Dec. 27, 2024

(30) Foreign Application Priority Data
Jan. 24, 2024 (TR) 2024/000836

(51) Int. Cl. G01N 22/02; H01Q 1/22

(52) U.S. Cl. CPC G01N 22/02; H01Q 1/22

(57) ABSTRACT

The present invention relates to a wireless, flexible RF (radio frequency) sensor (1) which can sense the ionic concentration and/or solid impurity changes of a liquid contained in a dielectric container independently of each other.

### CROSS-REFERENCE TO RELATED APPLICATION

This applications claims priority from Turkish Application No. 2024/000836 filed 24 Jan. 2024 the subject matter of which is incorporated herein by reference in its entirety.

### TECHNICAL FIELD

The present invention relates to a wireless, flexible RF (radio frequency) sensor which can sense the ionic concentration and/or solid impurity changes of a liquid contained in a dielectric container independently of each other.

### BACKGROUND OF THE INVENTION

Analyzing the quality or quantity of the contents of a dielectric container wirelessly has important results. This capability is particularly important when the chemical composition of hazardous, corrosive or sensitive liquids in dielectric containers is of concern. However, today, in order to detect the quality of the liquid in containers containing corrosive and toxic materials, it is needed to take a sample from the container and this situation poses risks and difficulties for the testers. Therefore, there is a need for a new sensor which eliminates the need for taking samples in order to obtain information about the quality and content of hazardous materials in the container and enables impurity and ionic changes to be detected independently of direct contact with the material in the container.

In the state of art, wireless sensors cause shifts in the spectral signal during the change of dielectric in the environment. Sensors that sense whether a dielectric material is present in the electromagnetic field emitted by the wireless sensor by observing spectral shifts are common in the literature (See also, Ali M. Albishi, “Three-Dimensional Split-Ring Resonators-Based Sensors for Fluid Detection”, IEEE SENSORS JOURNAL, VOL. 21, NO. 7, APR. 1, 2021). These studies are not suitable for observing current change and are suitable for use in isolated and controlled environments due to their high sensitivity to the external environment. In order to avoid this necessity, they are designed in smaller sizes to prevent the electromagnetic field from spreading over a large area.

The Korean patent document no. KR20220030600, an application included in the state of the art, discloses a sensor for wirelessly detecting an organic compound gas based on an energy harvesting meta-material and a breathalyzer using the same. The invention subject to the said Korean patent document is a sensor for wirelessly detecting an organic compound gas based on an energy harvesting meta-material and a breathalyzer using the same. This is a system which can overcome restrictive elements such as a gas detection space restriction, a manufacturing costs and process restriction, a detectable concentration restriction. According to an example of an embodiment of the related invention, a unit consisting of an energy-harvesting meta-material comprises an energy harvesting meta-material unit composed of a meta-material and receiving incident radio frequency (RF) waves to store the waves as electric energy; a gas detection unit arranged at one side of the energy harvesting meta-material unit, containing an ionic electrolyte as a detection film and changing an electrical property of the detection film according to interaction between the detection film and the organic compound gas; and an output circuit unit arranged on the other side of the energy harvesting meta-material unit and outputting energy harvesting data changed according to the electrical property of the detection film.

### SUMMARY OF THE INVENTION

An object of the present invention is to realize a wireless, flexible RF sensor which can sense the ionic concentration and/or solid impurity changes of a liquid independently of each other in a spectral and time-dependent manner.

Another object of the present invention is to realize a sensor which enables the impurities in a liquid that may be toxic or corrosive in a dielectric container to be detected in a non-contact manner without the need for sampling the liquid.

### DETAILED DESCRIPTION OF THE INVENTION

“An RF Sensor” realized to fulfil the objectives of the present invention is shown in the figures attached, in which:

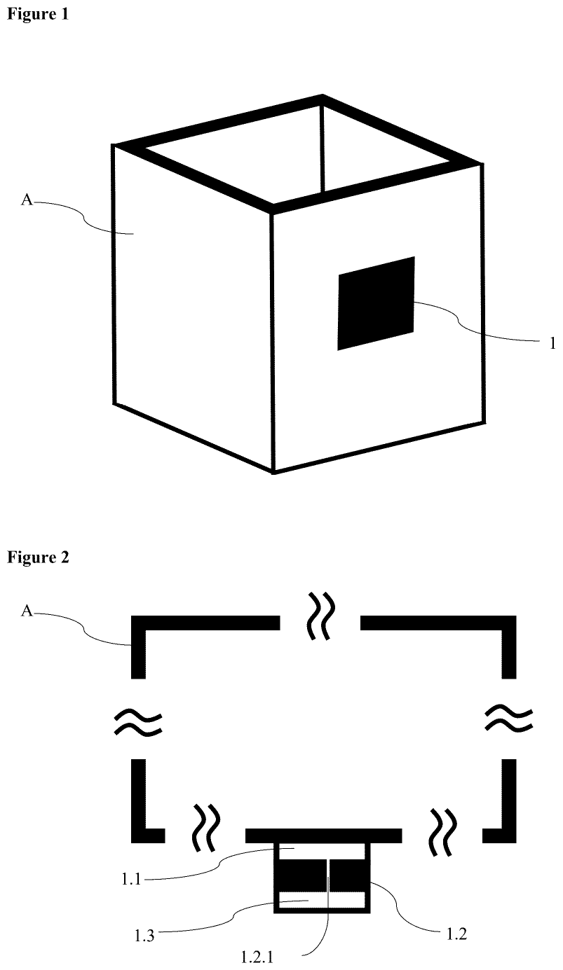

FIG. 1 is a general view of the system in which the inventive sensor is located.

FIG. 2 is a sectional view from the top of the system in which the inventive sensor is located.

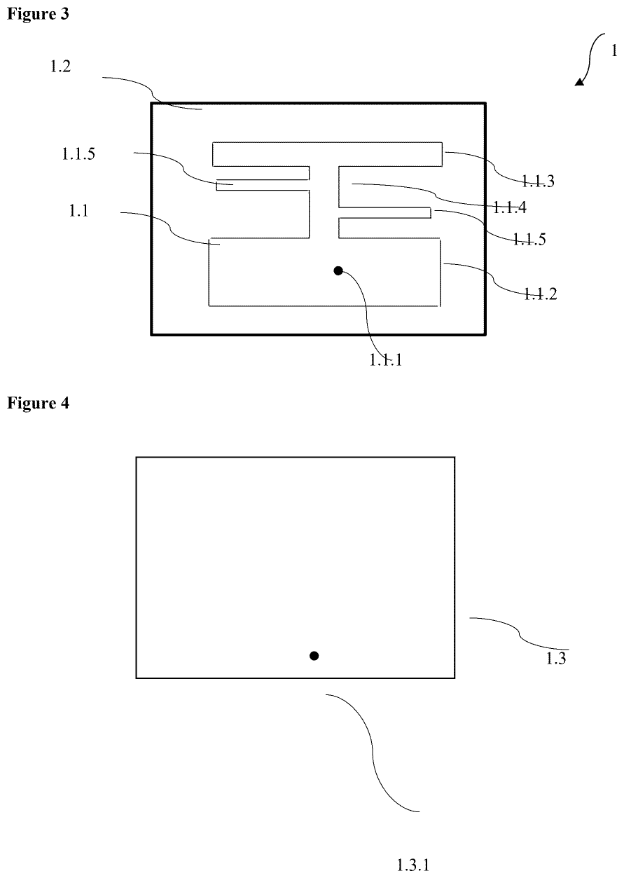

FIG. 3 is a front view of the inventive exemplary sensor.

FIG. 4 is a rear view of the inventive exemplary sensor.

The components illustrated in the figures are individually numbered, where the numbers refer to the following:
1. Sensor
   1.1. Front Layer
      1.1.1. RF feeding point
      1.2.1. Feeding patch
      1.1.3. Main radiation patch
      1.1.4. Transmission line
      1.1.5. Tuning stub
   1.2. Intermediate layer
      1.2.1 RF feeding path
   1.3. Rear layer
      1.3.1. RF feeding connection point
A: Liquid containing dielectric material/container

The inventive wireless and flexible RF sensor (1) which can sense the ionic concentration and/or solid impurity changes of a liquid independently of each other in a spectral and time-dependent manner comprises
at least one front layer (1.1) which has a planar structure comprising an RF feeding point (1.1.1), a feeding patch (1.1.2) on which the RF feeding point (1.1.1) is located, a main radiation patch (1.1.3) located opposite the feeding patch (1.1.2), at least one transmission line (1.1.4) for transmitting radio frequencies from the feeding patch (1.1.2) to the main radiation patch (1.1.3), and at least one tuning stub (1.1.5) extending outward from the transmission line (1.1.4); and which is placed in such a way that one surface thereof is in contact with the outer surface of the dielectric container in which the material (liquid) intended to be tested is contained;
at least one intermediate layer (1.2) which is joined to the back of the front layer (1.1); whose part of the surface area that is not the front layer (1.1) is in contact with the outer surface of the dielectric container (A) in which the material (liquid) intended to be tested is contained; which can transmit radio frequency signals coming from the front layer (1.1) by means of the RF feeding path (1.2.1) that is a conductive material passing through it; and
at least one rear layer (1.3) which has an RF feeding connection point (1.3.1) connected to the RF feeding path (1.2.1) located in the intermediate layer (1.2); and one surface of which is joined in such a way that it is in contact with the surface of the intermediate layer (1.2) where the front layer (1.1) is not present.

The front layer (1.1) included in the inventive RF sensor (1) is made of a good conductive material and has a flexible structure that allows it to take the curved shape of cylindrical containers. The front layer (1.1) is configured to enable the radio frequency received from the RF feeding point (1.1.1) to be transmitted to the main radiation patch (1.1.3) through the transmission line (1.1.4) and to be transmitted to the intermediate layer (1.2) from there. The front layer (1.1) can be placed on curved surfaces with unequal inclination in two axes such as a sphere or a geoid.

The intermediate layer (1.2) included in the inventive RF sensor (1) is made of any flexible lossless or low-loss dielectric material having a relative permeability constant between 2 and 3 in the applied radio frequency range and a thickness of 0.1 mm to 1 mm. In one embodiment of the invention, the intermediate layer (1.2) is a Rogers Druid RT5880, a polyamide-based material or Teflon. The intermediate layer (1.2) is a dielectric layer that has dielectric properties, is planar, can have a triangular, rectangular or polygonal shape, and is in a flexible structure. The intermediate layer (1.2) is configured with an RF feeding path (1.2.1) that is a good conductive path to enable the radio frequency transmitted from the front layer (1.1) to be transmitted to the back layer (1.3).

The back layer (1.3) included in the inventive RF sensor (1) is made of a good conductive material and has a flexible structure that allows it to take the curved shape of cylindrical containers. The back layer (1.3) is metallic layer that is planar, can have a triangular, rectangular or polygonal shape, and is in a flexible structure. The back layer (1.3) is configured with an RF feeding connection point (1.3.1) that provides an external connection to allow the radio frequency transmitted from the intermediate layer (1.2) to be transmitted into the liquid intended to be tested and the resonant frequency value of the liquid to be detected.

The RF sensor (1) integrates in contact with the outer wall of the dielectric material (A) containing the liquid; radiates radio frequencies into the liquid through the dielectric material and electromagnetically interacts with the liquid and/or solid in the inner volume of the container (A); its spectral electromagnetic response changes as a result of the change in the ionic concentration of the liquid; its time-dependent electromagnetic response changes as a result of solid impurity; includes metal and dielectric layers that can have a pattern; and has a planar structure.

When the RF sensor (1) is placed on the outer surface of the dielectric container (A) containing the liquid whose ionic and/or solid impurity changes are intended to be determined, it emits electromagnetic waves within a certain radio frequency range into the liquid. When the electrical properties of the liquid change for any reason, a new equilibrium and a new resonance frequency are created and a shift in the resonance frequency occurs. This change enables changes in the ionic content of the liquid to be detected.

A wireless and flexible RF sensor (1) which is coupled to the dielectric container (A) and designed in the low microwave frequency band has the potential to effectively detect concentration changes of the liquid in the container (A) and detect whether solid contaminants have been added externally. The sensor (1) exhibits an exceptional sensitivity, capable of detecting solute concentrations in water as low as 3.125×10⁻³ M.

The RF sensor (1) performs wireless sensing through a dielectric wall without the need for direct contact with the material medium to be tested. Being independent of direct contact with the medium not only allows the sensor (1) to be used for corrosive and toxic materials, but also eliminates the need to take samples from test subjects. This means that samples kept in dielectric containers can be characterized wirelessly from the outside. In addition, the connection of the sensor (1) to the dielectric material of the container (A) and the material being tested results in minimal back radiation from the sensor (1) and reflections from the sensor/dielectric wall, dielectric wall/material being tested interface, which reduces noise and improves the performance of the sensor. The sensor (1) can be designed on a flexible sublayer that allows it to take the curved shape of cylindrical containers. The low operating frequency (500-900 MHz) of the sensor (1) makes the circuit required to operate the sensor less expensive and less power consuming. The connection between the sensor (1), the dielectric wall and the material being tested results in very low amounts of reflected waves from the interfaces and this reduces the amount of noise sensed by the sensor. The reduction in noise level is directly proportional to the increase in SNR (Signal-to-Noise) and the improvement in detection sensitivity.

It is possible to develop various embodiments of the inventive “An RF Sensor (1)”; the invention cannot be limited to examples disclosed herein and it is essentially according to claims.

1. An RF sensor (1) used to sense ionic concentration and/or solid impurity changes of a liquid characterized in that
it is integrated in contact with the outer wall of the dielectric material (A) containing the liquid;
it radiates radio frequencies into the liquid through the dielectric material and electromagnetically interacts with the liquid and/or solid in the inner volume of the container (A)
its spectral electromagnetic response changes as a result of the change in the ionic concentration of the liquid;
its time-dependent electromagnetic response changes as a result of solid impurity;
it has metal and dielectric layers that can have a pattern; and
has a planar structure.

2. A wireless and flexible RF sensor (1) which can sense the ionic concentration and/or solid impurity changes of a liquid independently of each other in a spectral and time-dependent manner according to claim 1; characterized in that it comprises
at least one front layer (1.1) which has a planar structure comprising an RF feeding point (1.1.1), a feeding patch (1.1.2) on which the RF feeding point (1.1.1) is located, a main radiation patch (1.1.3) located opposite the feeding patch (1.1.2), at least one transmission line (1.1.4) for transmitting radio frequencies from the feeding patch (1.1.2) to the main radiation patch (1.1.3), and at least one tuning stub (1.1.5) extending outward from the transmission line (1.1.4); and which is placed in such a way that one surface thereof is in contact with the outer surface of the dielectric container in which the material (liquid) intended to be tested is contained;
at least one intermediate layer (1.2) which is joined to the back of the front layer (1.1); whose part of the surface area that is not the front layer (1.1) is in contact with the outer surface of the dielectric container (A) in which the material (liquid) intended to be tested is contained; which can transmit radio frequency signals coming from the front layer (1.1) by means of the RF feeding path (1.2.1) that is a conductive material passing through it; and
at least one rear layer (1.3) which has an RF feeding connection point (1.3.1) connected to the RF feeding path (1.2.1) located in the intermediate layer (1.2); and one surface of which is joined in such a way that it is in contact with the surface of the intermediate layer (1.2) where the front layer (1.1) is not present.

3. An RF sensor (1) according to claim 1, characterized by the front layer (1.1) which has a flexible structure that allows it to take the curved shape of cylindrical containers.

4. An RF sensor (1) according to claim 1, characterized by the front layer (1.1) which can be placed on curved surfaces with unequal inclination in two axes such as a sphere or a geoid.

5. An RF sensor (1) according to claim 1, characterized by the front layer (1.1) which is configured to enable the radio frequency received from the RF feeding point (1.1.1) to be transmitted to the main radiation patch (1.1.3) through the transmission line (1.1.4) and to be transmitted to the intermediate layer (1.2) from there.

6. An RF sensor (1) according to claim 1, characterized by the intermediate layer (1.2) which is made of any flexible lossless or low-loss dielectric material having a relative permeability constant between 2 and 3 in the applied radio frequency range and a thickness of 0.1 mm to 1 mm.

7. An RF sensor (1) according to claim 6; characterized by the intermediate layer (1.2) an example of which is a Rogers Druid RT5880, a polyamide-based material or Teflon.

8. An RF sensor (1) according to claim 1, characterized by the intermediate layer (1.2) which is planar, can have a triangular, rectangular or polygonal shape, and is in a flexible structure.

9. An RF sensor (1) according to claim 1, characterized by the back layer (1.3) which is configured with an RF feeding connection point (1.3.1) that provides an external connection to allow the radio frequency transmitted from the intermediate layer (1.2) to be transmitted into the liquid intended to be tested and the resonant frequency value of the liquid to be detected.

10. An RF sensor (1) according to claim 1, which emits electromagnetic waves in any frequency range between 500 MHz and 900 MHz into the liquid when placed on the outer surface of the dielectric container (A) containing the liquid whose ionic or solid impurity changes are intended to be determined; creates a new equilibrium and a new resonance frequency of the system when the electrical properties in the liquid change for any reason; and enables the changes in the content of the liquid to be detected through the time-dependent changes that occur when a shift in the resonance frequency occurs.
